(19) United States
(12) Patent Application Publication
(10) Pub. No.: US 2024/0279427 A1
(43) Pub. Date: Aug. 22, 2024

(54) GRAPHENE-GELATIN COMPOSITE HYDROGEL

(71) Applicant: Gwangju Institute of Science and Technology, Gwangju (KR)

(72) Inventors: Jae Young LEE, Gwangju (KR); Jung Geon PARK, Gwangju (KR)

(73) Assignee: Gwangju Institute of Science and Technology, Gwangju (KR)

(21) Appl. No.: 18/569,618

(22) PCT Filed: Feb. 11, 2022
(86) PCT No.: PCT/KR2022/002079

§ 371 Date: Dec. 13, 2023

(30) Foreign Application Priority Data
Jun. 14, 2021 (KR) 10-2021-0076883

(51) Int. Cl. C08K 3/04; C08J 3/075

(52) U.S. Cl. CPC C08K 3/042; C08J 3/075; C08J 2389/00; C08K 2201/011

(57) ABSTRACT

The present invention provides: a composite hydrogel including gelatin and reduced graphene oxide: a preparation method therefor; and a conduit or film manufactured using the same, wherein the composite hydrogel of the present invention overcomes the low conductivity and brittleness of a conventional functional hydrogel to maintain, through excellent elasticity and excellent ductility, high electrical conductivity and mechanical properties even if repeatedly compressed and bent, thereby being variously usable as a platform material for a conductive hydrogel, and thus can be effectively used, in a field requiring a conductive hydrogel, as an in vivo tissue engineering scaffold, a drug delivery system, a flexible body-implantable electrode, and an electronic device, which move a lot.

### TECHNICAL FIELD

The present invention relates hydrogel containing gelatin, and more specifically, to a composite hydrogel comprising gelatin and reduced graphene oxide.

### BACKGROUND ART

Hydrogel is a soft material having unique properties such as excellent biocompatibility, high water content, excellent self-healing and self-recovery, and is an important material for medical engineering application and tissue engineering. Recently, there has been an increase in the development and research of functional hydrogels in which functions such as antioxidant properties, mechanical durability, and conductivity are imparted to hydrogels. Conductive hydrogels exhibit conductive properties and can be utilized in advanced application fields such as biological signal detection sensors, electroactive tissues, engineering actuators, and actuators. In particular, gelatin is a protein-based biopolymer obtained by hydrolysis of collagen and is widely used in food, cosmetics, and medical instruments because of its excellent biocompatibility, biodegradability, and biological functions.

However, additional crosslinking is required for gelation of gelatin, and conductive substances such as metal nanoparticles, carbon-based materials, and conductive polymers are added to impart conductivity to gelatin hydrogel polymers. When these conductive materials are added, the obtained products usually exhibit greatly low conductivity, the composites produced are usually brittle, or the mechanical hardness greatly increases. In particular, it is difficult to use such brittle conductive hydrogels as tissue engineering platforms in living bodies with a lot of movement, and it is disadvantageous to utilize such brittle conductive hydrogels as electronic devices because of conductivity loss due to structural cracks caused by bending or repeated fatigue. Therefore, such properties are still limitations of conductive hydrogels.

Accordingly, a new concept of functional hydrogel technology that maintains the inherent biological properties of gelatin as well as imparts mechanical stability and electrical properties is needed.

### SUMMARY OF INVENTION

### Technical Problem

An object to be achieved by the present invention is to provide a hydrogel that exhibits improved mechanical and electrical properties by maintaining the interaction between graphene and a hydrogel network and forming a distributed network on the whole.

Another object of the present invention is to provide a functional hydrogel that over comes the brittleness of a conventional functional hydrogel to maintain high electrical conductivity, mechanical ductility, and elasticity even if repeatedly being bent or fatigue, thereby being usable as a platform for in vivo tissue engineering and electronic devices.

The objects to be achieved by the present invention are not limited to the objects mentioned above, and other technical objects that are not mentioned will be clearly understood by those skilled in the art to which the present invention pertains from the description below.

### Solution to Problem

In order to achieve the objects, according to an aspect of the present invention, a composite hydrogel comprising gelatin and reduced graphene oxide is provided.

In an embodiment, the gelatin may be contained at 2% to 40% (w/v) with respect to a total amount of the composite hydrogel.

In an embodiment, the gelatin may be one selected from gelatin methacrylate, gelatin acrylate, or a mixture of gelatin methacrylate and gelatin acrylate.

In an embodiment, in a case where the gelatin is gelatin methacrylate, the gelatin methacrylate may have a degree of substitution of polymer of 10 to 100 based on a methacrylate group peak and an amine group peak of gelatin.

In an embodiment, the reduced graphene oxide may be contained at 0.05% (w/v) or more with respect to a total amount of the composite hydrogel.

In an embodiment, the gelatin and the reduced graphene oxide may be contained at a weight ratio of 2000:1 to 10:1.

In an embodiment, the composite hydrogel may have a ratio (I_{D}/I_{G}) of D-band intensity to G-band intensity of 1.0 or more in a Raman spectrum.

According to an aspect of the present invention, there is provided a method for preparing a graphene oxide/gelatin composite hydrogel, which includes preparing a mixed solution containing gelatin, graphene oxide, and a crosslinking agent; inducing crosslinking of the mixed solution to obtain a crosslinked product; and reducing the crosslinked product.

In an embodiment, the reduction may be conducted by incubating the crosslinked product in an ascorbic acid solution.

In an embodiment, the incubation may be performed at 30° C. to 45° C.

In an embodiment, the gelatin may be gelatin methacrylate, the crosslinking agent may be a thermal polymerization initiator, and the crosslinking may be induced by increasing a temperature. In this case, the thermal polymerization initiator may be ammonium persulfate, and the temperature may be increased by raising the temperature to 50° C. to 80° C.

In an embodiment, the gelatin may be gelatin methacrylate, the crosslinking agent may be a photopolymerization initiator, and the crosslinking may be induced by irradiation with ultraviolet light. In this case, the photopolymerization initiator may be Irgacure 2959 (2-hydroxy-4′-(2-hydroxyethoxy)-2-methylpropiophenone), and the irradiation with ultraviolet light may be irradiation for 10 to 1,000 seconds using a UV light source.

According to still another aspect of the present invention, a conduit manufactured using the composite hydrogel is provided.

According to still another aspect of the present invention, a film manufactured using the composite hydrogel is provided.

### Advantageous Effects of Invention

According to the present invention, it has been found out that a composite hydrogel comprising gelatin and reduced graphene oxide overcomes the problems of low conductivity and brittleness of conventional conductive hydrogels to maintain, through excellent elasticity and excellent ductility, high electrical conductivity and mechanical properties even if repeatedly compressed and bent.

Therefore, the graphene oxide/gelatin composite hydrogel of the present invention can be variously usable as a platform material of conductive hydrogels, and thus can be effectively used, in a field requiring conductive hydrogels, as an in vivo tissue engineering scaffold, a drug delivery system, a flexible body-implantable electrode, and an electronic device, which move a lot.

The effects of the present invention are not limited to the effects described above, and should be understood to include all effects that can be inferred from the configuration of the invention described in the description or claims of the present invention.

### BRIEF DESCRIPTION OF DRAWINGS

FIG. 1 is a photograph of a r (GO/gelatin) hydrogel film formed by fabrication of a chemically crosslinked GO/gelatin hydrogel and subsequent mild chemical reduction of r (GO/gelatin);

FIG. 2 is 1H NMR spectra of gelatin and GelMA;

FIG. 3 illustrates the fabrication process of a conductive r (GO/GelMA) hydrogel formed by polymerization of a GO/GelMA composite hydrogel and subsequent mild chemical reduction of r (GO/GelMA);

FIG. 4 illustrates a photograph of a conductive r (GO/GelMA) hydrogel film formed by photopolymerization of a GO/GelMA composite hydrogel using irradiation with ultraviolet light and subsequent mild chemical reduction of r (GO/GelMA);

FIG. 5 is a photograph of an anulus mold and a conduit fabrication process;

FIG. 6 is a photograph (scale: 800 μm) of fabricated anulus conduits of GelMA, GO/GelMA, and r (GO/GelMA);

FIG. 7 illustrates the results of evaluating the properties of a gelatin-based conductive hydrogel, (A) the intensities in the Raman spectra of GO/GelMA and r (GO/GelMA) obtained after various reduction times, (B) the results showing the ratio (I_{D}/I_{G}) of D-band intensity to G-band intensity in the Raman spectra, (C) the Young's modulus and (D) conductivity of GelMA, GO/GelMA and r (GO/GelMA) hydrogels, and (E) Bode plots of the electrochemical impedance spectra (EIS) of various hydrogels;

FIG. 8 illustrates cyclic voltammograms of GelMA, GO/GelMA, and r (GO/GelMA), and illustrates the results of attaching each sample to an electrode and performing cyclic voltammetry in PBS (10 mM, pH 7.4) at a scanning speed of 0.05 V s−1;

FIG. 9 illustrates EIS spectra of various r (GO/GelMA) samples prepared to have different rGO contents, where EIS is measured in PBS;

FIG. 10 illustrates the results showing the in vitro electrical and electrochemical stability of r (GO/GelMA) in PBS at 37° C., where the conductivity and impedance are measured on days 0, 1, 3, 5, and 7 (n=3);

FIG. 11 illustrates the results of evaluating the properties of a r (GO/GelMA) conduit, and illustrates (A) a photograph of the r (GO/GelMA) conduit when being bent and (B) a photograph of the r (GO/GelMA) conduit in a state of being connected to a cable and an LED bulb;

FIG. 12 illustrates the fatigue test results of various samples through cyclic stress testing (each conduit is compressed to 30% strain for up to 100 repetitions, and the photograph is of the conduit after compression (100 repetitions)); and

FIG. 13 illustrates the antioxidation activity analysis, where (A) a hydroxyl radical solution is prepared per one sample using 600 μl of 2 mM FeSO₄ and 500 μl of 360 μg ml-1 safranin O. Each 4 mm long conduit is incubated in a 6 wt % H₂O₂ solution at 55° C. for 1 hour, and then the solution is mixed with the hydroxyl radical solution. (B) a DPPH solution having an absorbance of 0.7 at 517 nm is prepared by diluting a 0.1 mM stock solution with 80% methanol. Each conduit is incubated in the DPPH solution at 25° C. for 1 hour. (C) an ABTS solution having an absorbance of 0.7 at 732 nm is prepared with DPBS from a stock solution of 2.6 mM potassium persulfate and 7.4 mM ABTS in DPBS. Each conduit is incubated in the ABTS solution at 25° C. for 30 minutes. (D) a superoxide radical solution is prepared with nicotinamide adenine dinucleotide (468 μM), nitroblue tetrazolium (156 μM), and phenazine methosulfate (60 μM) in 1×PBS (pH 7.4). Each conduit is incubated in the superoxide radical solution at 25° C. for 30 minutes. The absorbance of each (hydroxyl, DPPH, ABTS and superoxide radicals) is measured at 492, 517, 732 and 560 nm, respectively, using a microplate reader (Varioskan™ LUX multimode microplate reader), and the removal activity is calculated using Equation 1 below:

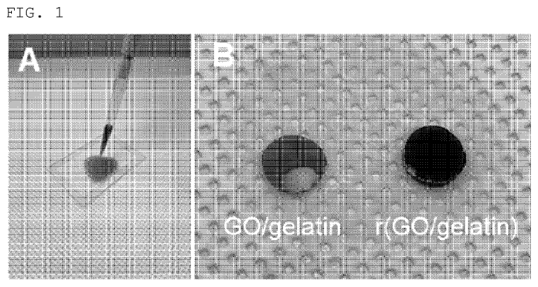

$$Removal activity ( \% ) = ( 100 - sample ) / control \times 100 \qquad \text{<Equation 1>}$$

### DESCRIPTION OF EMBODIMENTS

The present invention provides a composite hydrogel containing gelatin and reduced graphene oxide.

In the present invention, in order to produce a gelatin-based hydrogel, gelatin, graphene oxide, and a chemical crosslinking agent were mixed and crosslinked to prepare a gelatin hydrogel in which graphene oxide was uniformly distributed. As another method, a gelatin modifier (GelMA) obtained by polymerizing methacrylate into gelatin was synthesized and contained, and for the degree of distribution, the GelMA and graphene oxide were mixed, a thermal initiator or a photoinitiator was added, and then thermally initiated or photoinitiated polymerization was induced to produce a GelMA hydrogel in which graphene oxide was uniformly distributed. Thereafter, through a reduction process under mild conditions, a reduced graphene oxide/gelatin composite hydrogel having an increased conductivity and enhanced functionality while maintaining the interaction between graphene and gelatin was obtained.

The composite hydrogel of the present invention contains gelatin. Gelatin is a substance obtained from animal tissues (skin and the like) through a hydrolysis process, and gelatin has a number of functionalizing groups such as an amine group and a carboxyl group. These functionalizing groups of gelatin form new bonds and networks through hydrogen bonding with graphene oxide and charge interactions, and the mechanical properties are thus enhanced. In addition, the degree of distribution of graphene within the gelatin network increases by the charge interactions and the like as above, and this may contribute to the formation of a conductive path on the whole.

In an embodiment, the gelatin may be used at any concentration without limitation as long as a gelatin network can be formed within the composite hydrogel, and may be contained at 2% to 40% (w/v), preferably 10% to 30% (w/v), more preferably 15% to 25% (w/v) with respect to the total amount of the composite hydrogel, but is not limited thereto.

In an embodiment, the gelatin may be one selected from gelatin methacrylate, gelatin acrylate, or a mixture of gelatin methacrylate and gelatin acrylate.

In an embodiment, in a case where the gelatin is gelatin methacrylate, gelatin methacrylate may be obtained by substituting the amine group of gelatin with a methacrylate group. At this time, the degree of substitution of polymer may be 10 to 100, preferably 20 to 90, more preferably 30 to 80, most preferably 40 to 70 based on the methacrylate group peak and the amine group peak of gelatin in the NMR spectrum.

The reduced graphene oxide used in the present invention may be contained at 0.05% (w/v) or more with respect to the total amount of the composite hydrogel. The composite hydrogel containing reduced graphene oxide at 0.05% (w/v) or more had a lower impedance value than a composite hydrogel containing reduced graphene oxide at a concentration lower than this, and this indicates that the reduced graphene oxide content of 0.05% (w/v) in the hydrogel is critical to the formation of a conductive percolation network.

In the composite hydrogel of the present invention, gelatin and reduced graphene oxide contained therein may be contained at a weight ratio of 2000:1 to 10:1, preferably 1000:1 to 20:1, more preferably 200:1 to 20:1.

The composite hydrogel of the present invention can control the degree of reduction of graphene oxide contained therein, and at this time, the ratio (I_{D}/I_{G}) of D-band intensity to G-band intensity in the Raman spectrum may be adopted as an indicator of the degree of reduction. In an embodiment, the composite hydrogel may have a ratio (I_{D}/I_{G}) of D-band intensity to G-band intensity of 1.0 or more, preferably 1.05 or more in the Raman spectrum.

The present invention also provides a method for preparing a graphene oxide/gelatin composite hydrogel, which includes preparing a mixed solution containing gelatin, graphene oxide, and a crosslinking agent; inducing crosslinking of the mixed solution to obtain a crosslinked product; and reducing the crosslinked product.

The graphene oxide/gelatin composite hydrogel of the present invention is a conductive hydrogel and is produced using gelatin (for example, gelatin methacrylate (GelMA)) and graphene oxide (GO). Gelatin has been widely used to synthesize hydrogels in various tissue engineering application fields and is known to have a positive effect on various tissue regeneration. The graphene oxide/gelatin composite hydrogel contains GO as a conductive and antioxidant component, and GO is provided as a hydrogel in a reduced state, that is, r (GO/gelatin) in order to improve the electrical properties and functionality of hydrogel. In the present invention, chemical reduction was post-performed, and it has been confirmed that the electrical properties of the GO-containing hydrogel are enhanced by thus restoring the sp²-carbon bond while minimizing the aggregation of reduced GO (rGO). As rGO maintains the state of being distributed in the hydrogel network by this production process, a composite hydrogel that exhibits conductivity, and at the same time, maintains mechanical ductility can be obtained.

The method for preparing a graphene oxide/gelatin composite hydrogel of the present invention includes preparing a mixed solution containing gelatin, graphene oxide, and a crosslinking agent. The step is a step of preparing a mixed solution of graphene oxide and gelatin and then adding a chemical crosslinking agent thereto. As the chemical crosslinking agent used in the step, a commonly used crosslinking agent, that is, any crosslinking agent that can chemically crosslink gelatin may be used without limitation. The chemical crosslinking agent may be, for example, glutaldehyde, but is not limited thereto.

This step is a step of mixing the components required for a reaction before the polymerization reaction takes place since the polymerization reaction takes place immediately when a crosslinking agent is added to the mixed solution of graphene and oxide gelatin and the polymerization conditions (increase in temperature or irradiation with ultraviolet light) described below are adjusted. In the step, gelatin and graphene oxide are as described above. As the crosslinking agent used in this step, a commonly used crosslinking agent, that is, any initiator that can thermally polymerize or photopolymerize gelatin (for example, gelatin methacrylate) may be used without limitation. The crosslinking agent may be, for example, ammonium persulfate e case of thermal polymerization and Irgacure 2959 (2-hydroxy-4′-(2-hydroxyethoxy)-2-methylpropiophenone) in the case of photopolymerization, but is not limited thereto.

The method for preparing a graphene oxide/gelatin composite hydrogel of the present invention includes inducing crosslinking of the mixed solution to obtain a crosslinked product.

In an embodiment, the gelatin may be gelatin methacrylate, the crosslinking agent may be a thermal polymerization initiator, and the crosslinking may be induced by increasing a temperature. In this case, the thermal polymerization initiator may be ammonium persulfate. Increasing the temperature in the step means increasing the temperature to a temperature at which the polymerization reaction of gelatin methacrylate proceeds. For example, the temperature may be increased to 50° C. to 80° C., preferably 55° C. to 70° C., more preferably 58° C. to 65° C. The polymerization reaction may be conducted for a polymerization reaction time commonly adopted in the art. In this process, gelatin methacrylate is polymerized to form a gelatin network, and the degree of distribution of graphene oxide increases within the gelatin network, so that a composite hydrogel in which conductive paths are connected to each other on the whole can be obtained.

In an embodiment, the gelatin may be gelatin methacrylate, the crosslinking agent may be a photopolymerization initiator, and the crosslinking may be induced by irradiation with ultraviolet light. In this case, the photopolymerization initiator may be Irgacure 2959 (2-hydroxy-4′-(2-hydroxyethoxy)-2-methylpropiophenone). Irradiation with ultraviolet light in the step means inducing the polymerization reaction of gelatin methacrylate by ultraviolet light for irradiation. The time for irradiation with ultraviolet light refers to the time during which the polymerization reaction of gelatin methacrylate can be induced, and refers to, for example, irradiation with ultraviolet light for 10 to 1,000 seconds, preferably 1 to 600 seconds, more preferably 10 to 300 seconds, most preferably 30 to 180 seconds using a UV light source.

The method for preparing a graphene oxide/gelatin composite hydrogel of the present invention includes reducing the crosslinked product. The step is a step of increasing the degree of reduction of graphene oxide contained in the graphene oxide/gelatin composite hydrogel. For the irradiation, any reduction process commonly used in the art may be used without limitation, and the reduction may be, for example, incubating the polymerized product in an ascorbic acid solution. The concentration of the ascorbic acid solution may be 0.2 to 20 mg/ml, preferably 0.5 to 10 mg/ml. In an embodiment, the incubation may be performed at 30° C. to 45° C., preferably 33° C. to 42° C., more preferably 35° C. to 40° C. Additionally, the incubation may be the time required for a reduction reaction commonly used in the art, and may be preferably 1 to 60 hours, more preferably 12 to 36 hours.

The present invention also provides a conduit and a film that are manufactured using the composite hydrogel. The composite hydrogel of the present invention can be fabricated into tissue engineering scaffolds in various forms, such as conduits and films. In other words, the composite hydrogel can be manufactured into a product having a desired shape by using the composite hydrogel preparation process as it is and using a casting mold or the like. For example, the composite hydrogel may be fabricated into a conduit shape using an anulus mold, and may be fabricated into a film form using a flat plate. The anulus conduit or film manufactured in this way maintains its shape well even after reduction, and its color changes from brown to dark black by chemical reduction.

Hereinafter, the present invention will be described in more detail through Examples. However, the following Examples are for illustrating the present invention, and the scope of the present invention is not limited thereto.

### EXAMPLES

### 1. Experiment

### (1) Substances and Reagents

Methacylic anhydride, ammonium persulfate (APS), and L-ascorbic acid were procured from Sigma-Aldrich (St. Louis, MO, USA). GO aqueous solution (6 mg mL-1) was purchased from Graphene Supermarket Inc. (Calverton, NY, USA). Dulbecco's phosphate-buffered saline (DPBS) was purchased from Gibco (Rockville, MD, USA).

### (2) Fabrication of r (GO/Gelatin) Film

A hydrogel pre-solution was prepared by dissolving gelatin (20% (w/v)) and GO (0.2% (w/v)) in water. Afterwards, glutaraldehyde (0.75% (v/v)) was added, and the mixture was stirred quickly and placed in a casting mold so that the reaction proceeded. Afterwards, the produced hydrogel was taken out of the mold and washed with ultrapure water to obtain a GO/gelatin hydrogel. Afterwards, the GO/gelatin hydrogel obtained above was placed in an ascorbic acid solution at a concentration of 2 mg/ml and reduced at 37° C. for 24 hours to fabricate a r (GO/gelatin) hydrogel. Afterwards, the hydrogel was taken out and washed with ultrapure water to finally obtain a r (GO/gelatin) hydrogel.

### (3) Synthesis of Gelatin Methacrylate (GelMA)

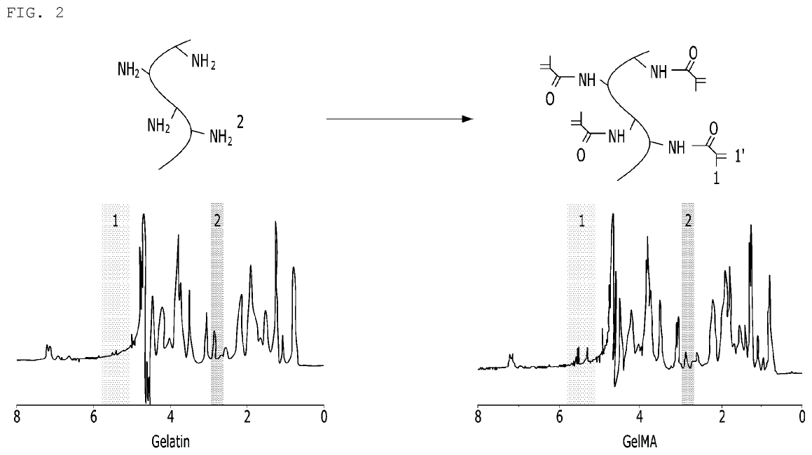

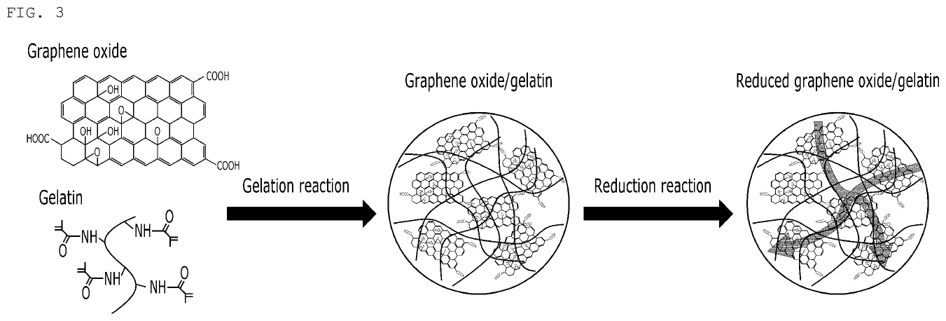

Gelatin (10% (w/v)) was completely dissolved in DPBS at 60° C. While vigorous stirring was performed, 0.8 mL of methacrylic anhydride per gram of gelatin was added dropwise to the gelatin solution. The mixture was further stirred at 60° C. for 2 hours and then diluted with preheated DPBS to terminate the reaction. The solution was dialyzed against a 10 kDa membrane (Spectrum Laboratories Inc, USA) at 40° C. for 5 days. After dialysis, the solution was filtered through a 0.2 μm filter, lyophilized, and stored at −20° C. The degree of substitution of the synthesized GelMA was determined by 1H-NMR spectroscopy (FIG. 2). The degree of substitution of the synthesized GelMA was calculated to be 51.5±3.5 based on the peak (methacrylate group) at 5 to 6 ppm and the amine group peak at 2.9 ppm (gelatin).

### (4) Fabrication of r (GO/GelMA) Hydrogel Film

A hydrogel pre-solution was prepared by dissolving GelMA (20% (w/v)) and GO (0.2% (w/v)) in water. Afterwards, the photoinitiator Irgacure 2959 (1% (v/v)) was added, the mixture was stirred quickly, and then the reaction was conducted for 5 to 10 minutes under a UV light source. Afterwards, the produced hydrogel was taken out of the mold and washed with ultrapure water to obtain a GO/GelMA hydrogel. Afterwards, the GO/GelMA hydrogel obtained above was placed in an ascorbic acid solution at a concentration of 2 mg/ml and reduced at 37° C. for 24 hours. Afterwards, the hydrogel was taken out and washed with ultrapure water to finally obtain a r (GO/GelMA) hydrogel.

### (5) Fabrication of r (GO/GelMA) Hydrogel Conduit

A pre-polymer solution of 20% (w/v) GelMA, 0.2% (w/v) GO, and 2% (w/v) ammonium persulfate was prepared, and GO-containing GelMA (namely, GO/GelMA) was fabricated. The mixed pre-polymer solution was transferred to various casting molds. The conduit mold consisted of a glass tube (internal diameter 2.2 mm) and a stainless steel rod (diameter 1.2 mm), with the rod fixed in the center of the glass tube. In order to manufacture a hydrogel film, a flat mold was constructed with two parallel glass plates spaced 0.5 mm apart. The mixed pre-polymer solution was placed in each casting mold and incubated at 60° C. for 6 hours for polymerization.

The GO/GelMA hydrogel was incubated in 2 mg mL-1 L-ascorbic acid solution at 37° C. for 24 hours for chemical reduction, thereby producing r (GO/GelMA).

### (6) Evaluation of Properties of Various Hydrogel Conduits

The chemical reduction of GO component contained in the hydrogel was investigated by performing Raman spectroscopic analysis. Each hydrogel was decomposed with 2.5 U mL-1 of collagenase 1 overnight at 37° C. Next, the solution was drop-cast on a clean glass slide at 100° C. and analyzed with a 532 nm laser in a Raman spectrograph (UniRaman; UniThink Inc., Korea).

In order to evaluate the mechanical properties of hydrogels, the shear modulus was measured at 37° C. and a 0.5% strain in the frequency range of 0.1 to 10 Hz using a rheometer (Kinexus; Malvern Instruments, Worcestershire, UK). The Young's modulus was calculated from the shear modulus at a frequency of 1 Hz as previously described.

The EIS and conductivity of conductive hydrogels were measured. For EIS measurement, flat hydrogel disks were prepared, pre-incubated in DPBS, and then disposed between two parallel gold-coated glass electrodes. An alternative sinusoidal potential of 10 mV was applied in the frequency range of 1 to 105 Hz using a computer-assisted electrochemical instrument (VersaSTAT3, Princeton Applied Research, Princeton, NJ, USA). The four-point probe method was used to measure the conductivity of hydrogels. the sheet resistance was measured by linear scanning voltammetry at a scan rate of 50 mV s⁻¹, and the conductivity was calculated from the sheet resistance described previously.

### (7) Statistical Analysis

All results were statistically analyzed and expressed as mean±standard deviation. Statistical analysis was performed using one-way ANOVA together with Tukey's post hoc test at a significance level of 0.05, unless otherwise specified.

### 2. Results

### Preparation of Composite Hydrogel

A GO/gelatin composite hydrogel could be synthesized using a chemical crosslinking agent (FIG. 2), and a r (GO/gelatin) film was obtained by additionally chemically reducing the GO/gelatin composite hydrogel under mild conditions (2 mg mL-1 L-ascorbic acid, 37° C.) to improve conductivity. Mild chemical reduction of the GO/gelatin film caused a color change from brown to dark black, indicating the reduction of GO component in the composite hydrogel.

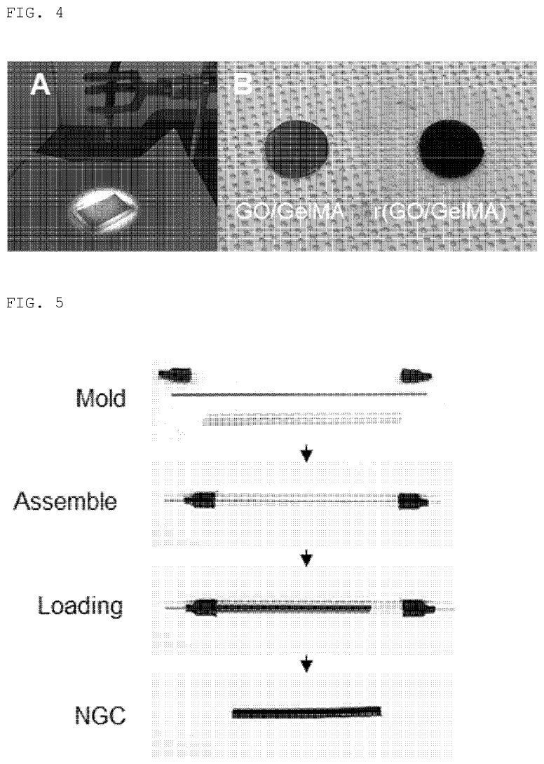

At the time of photopolymerization, a GO/GelMA composite hydrogel was synthesized through UV photopolymerization, and a r (GO/GelMA) composite film was obtained by additionally chemically reducing the GO/GelMA composite hydrogel under mild conditions (2 mg mL-1 L-ascorbic acid, 37° C.) to improve conductivity (FIG. 4). Mild chemical reduction of the GO/GelMA film caused a color change from brown to dark black, indicating the reduction of GO component in the composite hydrogel.

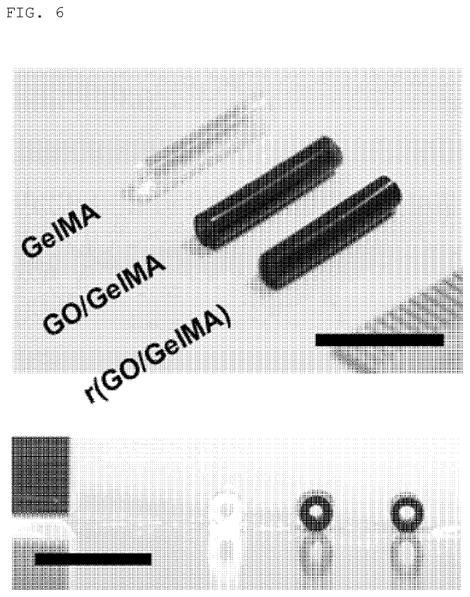

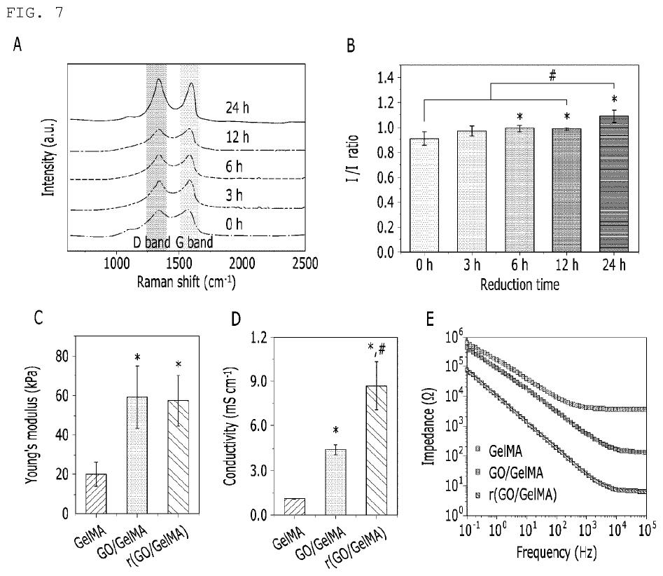

At the time of thermal polymerization, a GO/GelMA composite hydrogel was synthesized by applying heat to the hydrogel pre-solution, and r (GO/GelMA) was obtained by additionally chemically reducing the GO/GelMA composite hydrogel under mild conditions (2 mg mL-1 L-ascorbic acid, 37° C.) to improve conductivity (FIG. 6). GelMA, GO/GelMA, and r (GO/GelMA) conduits were successfully fabricated using anulus molds having similar dimensions (FIGS. 5 and 6). The inner diameter and wall thickness of this conduit were about 1.2 mm and 0.5 mm, respectively. From these results, it can be seen that the shape and size of GO-containing conduits are well maintained even after reduction. Mild chemical reduction of the GO/GelMA conduit caused a color change from brown to dark black, indicating the reduction of GO component in the composite hydrogel.

### (2) Material Properties of Composite Hydrogel: Raman Spectroscopic Analysis

The reduction of GO component in r (GO/GelMA) was investigated using Raman spectroscopy (FIG. 7A). The peak intensity ratio of D-band (I_{D}) to G-band (I_{G}) was compared as an indicator of the degree of reduction of rGO (FIG. 7B). The I_{D}/I_{G} ratio of samples gradually increased from 0.909±0.05 to 1.09±0.05 as the reduction time increased to 24 hours. r (GO/GelMA) samples reduced for 6 hours or more had significantly higher I_{D}/I_{G} ratio values compared to unreduced GO/GelMA (0 hours). In particular, r (GO/GelMA) reduced for 24 hours had a significantly higher I_{D}/I_{G} ratio compared to other samples. In subsequent experiments, the hydrogel reduced for 24 hours was used.

### (3) Mechanical and Electrical Properties of Composite Hydrogel

The Young's modulus of a GelMA hydrogel not containing GO was measured to be 20±6 kPa. When GO was contained (0.2 mg mL-1) in GelMA, the elasticity increased by about 3-fold. These results indicate that additional molecular interaction between GO and gelatin improves mechanical properties of the hydrogel. In addition, the Young's modulus (59±16 kPa) of GO/GelMA and the Young's modulus (57±13 kPa) of r (GO/GelMA) were not statistically different from each other (FIG. 7C), and this means that the mild chemical reaction conducted in the present invention does not cause substantial changes in the molecular interaction between GO (or rGO) and GelMA.

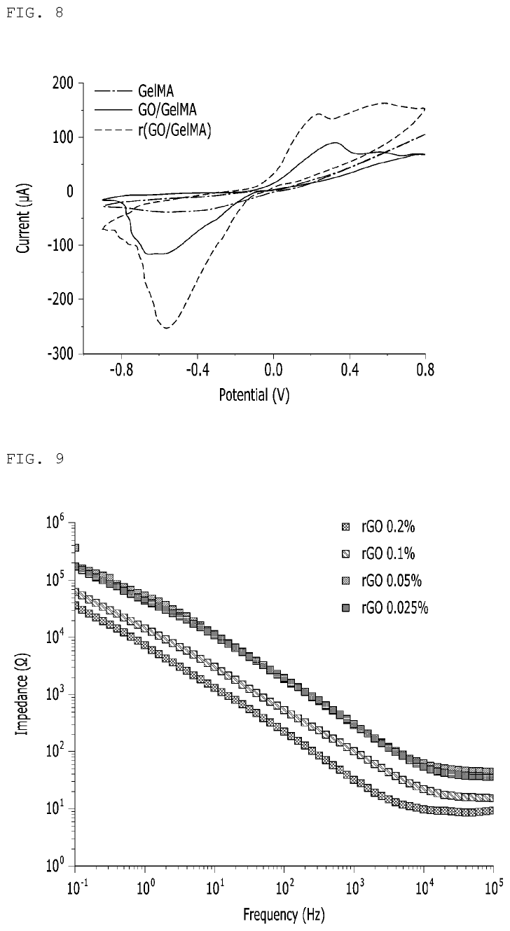

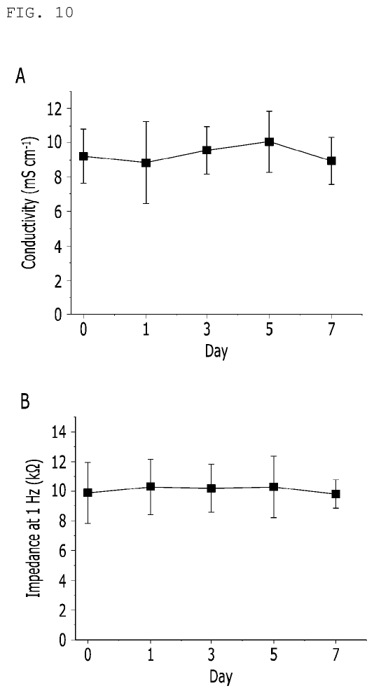

The electrical properties of various hydrogel samples were investigated using conductivity and electrochemical impedance spectra (EIS). GO/GelMA had a higher conductivity (4.4±0.4 mS cm⁻¹) than GelMA (1.1±0.1 mS cm⁻¹) (FIG. 7D). r (GO/GelMA) had the highest conductivity (8.7±1.6 mS cm⁻¹), and this indicates the contribution of the conductive rGO portion to the composite hydrogel (namely, r (GO/GelMA)). In addition, GelMA had a high impedance at all tested frequencies (0.1 to 105 Hz), but composite GelMA hydrogels containing GO or rGO had a low impedance as a result of measurement. r (GO/GelMA) had the lowest impedance at all frequencies (FIG. 7E). For example, the impedance values of GelMA, GO/GelMA, and r (GO/GelMA) at 1 Hz were 193±13 kΩ, 98±8 kΩ, and 10±1 kΩ, respectively. These results suggest that r (GO/GelMA) is conductive and mechanically flexible, and is thus suitable for the application field of biological tissues with movement. From the cyclic voltammetry results of samples (FIG. 8), it can be seen that GelMA does not have positive and negative peaks, and r (GO/GelMA) has a higher current and a higher capacitance than GO/GelMA. These results indicate that the conductivity and conduction area of r (GO/GelMA) have increased (FIG. 8). In order to determine the effect of rGO concentration on electrochemical properties, experiments were conducted by varying the rGO content in r (GO/GelMA) (FIG. 9). The impedance value of r (GO/GelMA) produced to have a rGO concentration of 0.1% or more was substantially lower than those of samples containing rGO at concentrations lower than this, which indicates that the rGO content of 0.1% in a hydrogel is critical to the formation of a conductive percolation network. In addition, the stability of the electrical and electrochemical properties of r (GO/GelMA) in PBS for 7 days was tested (FIG. 10). After 7 days of incubation, the conductivity and impedance of r (GO/GelMA) at 1 Hz remained similar to the original conductivity and impedance at 1 Hz (day 0).

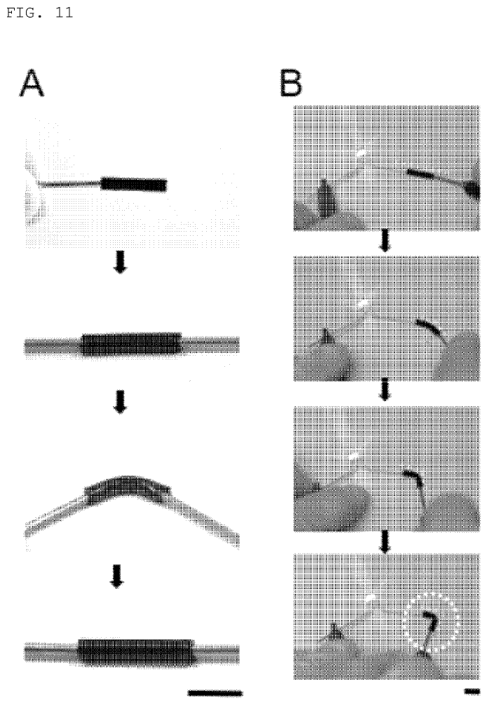

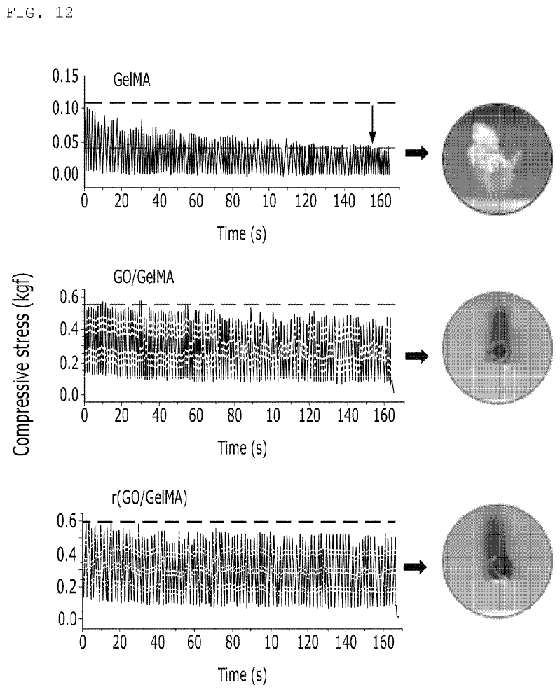

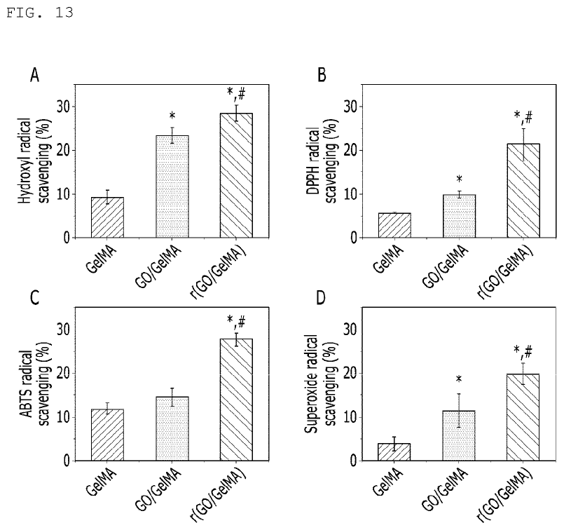

In order to investigate the feasibility of using conductive hydrogel-based conduits as tissue engineering implants, the flexibility and durability of the conduits were evaluated. As can be seen in FIG. 11A, the r (GO/GelMA) conduit was greatly flexible and could be bent without structural damage. In addition, even while being bent by about 90°, the conduit maintained the conductivity and maintained the glow of a light emitting diode (LED) bulb (FIG. 11B). Therefore, these flexibility and conductivity properties of r (GO/GelMA) conduits provide performance different from existing one. The mechanical durability of various conduits was tested by sequential cyclic compression (FIG. 12). During compression, the GelMA conduit gradually lost its mechanical strength, having about 37.5% of the initial compressive stress and severe structural damage after 100 repeated compressions. In contrast, GO/GelMA and r (GO/GelMA) conduits exhibited high levels of compressive stress even during repeated compressions. GO/GelMA and r (GO/GelMA) conduits exhibited about 85% of the initial compressive stress and exhibited excellent structural integrity.

### 3. Conclusion

With the goal of adding new functions to and improving functionality of conventional gelatin-based hydrogels, GO and gelatin (or GelMA) were polymerized and then chemically reduced to finally form a reduced graphene/gelatin composite hydrogel, whereby a hydrogel exhibiting improved conductivity and mechanical properties was fabricated. The material had a low Young's modulus (57±13 kPa), an excellent conductivity (8.7±1.6 mS cm⁻¹), a low impedance over a wide frequency range, flexibility, and durability (up to 500 repeated compressions). The material also exhibited improved properties of antioxidation. The multifunctional hydrogel obtained in this study can be applied to regeneration of various biological tissues, bioelectrodes, and interface materials.

### 4. Summary

Graphene oxide (GO) and gelatin were allowed to gel (polymerized) and chemically reduced to produce a reduced graphene oxide/gelatin composite. The obtained material exhibits excellent conductivity, flexibility, and mechanical stability, and is suitable to be utilized as various materials in medical engineering, cosmetics, and the like. The conductive hydrogel fabricated in this study can be utilized in a number of fields where conductive hydrogels are applied, such as tissue engineering scaffolds, body-implantable flexible electrodes, and functional conduits for improving nerve regeneration.

The foregoing description of the present invention is for illustrative purposes only, and those skilled in the art to which the present invention pertains will understand that the present invention can be easily modified into other specific forms without changing its technical idea or essential features. Therefore, the embodiments described above should be understood in all respects as illustrative and not restrictive. For example, each component described as single may be implemented in a distributed manner, and similarly, components described as distributed may also be implemented in a combined form.

The scope of the present invention is indicated by the claims described below, and all changes or modified forms derived from the meaning and scope of the claims and their equivalent concepts should be construed as being included in the scope of the present invention.

1. A composite hydrogel comprising gelatin and reduced graphene oxide.

2. The composite hydrogel according to claim 1, wherein the gelatin is contained at 2% to 40% (w/v) with respect to a total amount of the composite hydrogel.

3. The composite hydrogel according to claim 1, wherein the gelatin is one selected from gelatin methacrylate, gelatin acrylate, or a mixture of gelatin methacrylate and gelatin acrylate.

4. The composite hydrogel according to claim 3, wherein the gelatin methacrylate has a degree of substitution of polymer of 10 to 100 based on a methacrylate group peak and an amine group peak of gelatin.

5. The composite hydrogel according to claim 1, wherein the reduced graphene oxide is contained at 0.05% (w/v) or more with respect to a total amount of the composite hydrogel.

6. The composite hydrogel according to claim 1, wherein the gelatin and the reduced graphene oxide are contained at a weight ratio of 2000:1 to 10:1.

7. The composite hydrogel according to claim 1, wherein the composite hydrogel has a ratio (I_{D}/I_{G}) of D-band intensity to G-band intensity of 1.0 or more in a Raman spectrum.

8. A method for preparing a graphene oxide/gelatin composite hydrogel, comprising:
preparing a mixed solution containing gelatin, graphene oxide, and a crosslinking agent;
inducing crosslinking of the mixed solution to obtain a crosslinked product; and
reducing the crosslinked product.

9. The method for preparing a graphene oxide/gelatin composite hydrogel according to claim 8, wherein the reduction is conducted by incubating the crosslinked product in an ascorbic acid solution.

10. The method for preparing a graphene oxide/gelatin composite hydrogel according to claim 9, wherein the incubation is performed at 30° C. to 45° C.

11. The method for preparing a graphene oxide/gelatin composite hydrogel according to claim 8, wherein the gelatin is gelatin methacrylate, the crosslinking agent is a thermal polymerization initiator, and the crosslinking is induced by increasing a temperature.

12. The method for preparing a graphene oxide/gelatin composite hydrogel according to claim 11, wherein the thermal polymerization initiator is ammonium persulfate.

13. The method for preparing a graphene oxide/gelatin composite hydrogel according to claim 11, wherein the temperature is increased by raising the temperature to 50° C. to 80° C.

14. The method for preparing a graphene oxide/gelatin composite hydrogel according to claim 8, wherein the gelatin is gelatin methacrylate, the crosslinking agent is a photopolymerization initiator, and the crosslinking is induced by irradiation with ultraviolet light.

15. The method for preparing a graphene oxide/gelatin composite hydrogel according to claim 14, wherein the photopolymerization initiator is Irgacure 2959 (2-hydroxy-4′-(2-hydroxyethoxy)-2-methylpropiophenone).

16. The method for preparing a graphene oxide/gelatin composite hydrogel according to claim 14, wherein the irradiation with ultraviolet light is irradiation for 10 to 1,000 seconds using a UV light source.

17. A conduit manufactured using the composite hydrogel according to claim 1.

18. A film manufactured using the composite hydrogel according to claim 1.
